(19) United States
(12) Patent Application Publication
(10) Pub. No.: US 2010/0143626 A1
(43) Pub. Date: Jun. 10, 2010

(54) MAGNESIUM ALLOY MATERIAL FOR FORMING, MAGNESIUM ALLOY FORMED BODY, AND MANUFACTURING METHOD OF MAGNESIUM ALLOY FORMED BODY

(76) Inventors: Masao Komai, Yamaguchi (JP); Koh Yoshioka, Yamaguchi (JP)

Correspondence Address: BROWDY AND NEIMARK, P.L.L.C.;624 NINTH STREET, NW, SUITE 300, WASHINGTON, DC, 20001-5303, US

(21) Appl. No.: 12/439,562

(22) PCT Filed: Aug. 28, 2006
(86) PCT No.: PCT/JP2006/316832

§ 371 Date: Feb. 12, 2010

(51) Int. Cl. B32B 1/02; B32B 27/40; B32B 27/38; B32B 15/08; B32B 27/30; B21B 45/00

(52) U.S. Cl. 428/35.7; 428/425.9; 428/418; 428/458; 428/463; 428/447; 428/433; 72/46

(57) ABSTRACT

A magnesium alloy material for forming which can yield a formed body with high formability without using a lubricating oil or a solid lubricant such as molybdenum disulfide, a magnesium alloy formed body which is obtained by forming the magnesium alloy material for forming, and a manufacturing method of the magnesium alloy formed body are provided. A magnesium alloy material for forming which exhibits a friction coefficient of 0.2 or below at a forming temperature of 350° C. or below is obtained by coating a surface of a magnesium alloy material with an organic resin such as a water-soluble urethane resin, a water-soluble polyester resin, a water-soluble acrylic resin or a water-soluble epoxy resin or a resin obtained by modifying any of these organic resins, or an organic resin formed of any of these resins which contains a silane coupling agent, a colloidal silica, a lubricant, a metal alkoxide or the like. Further, a magnesium alloy formed body such as an automobile part or a container is manufactured by forming a magnesium alloy material for forming.

### TECHNICAL FIELD

The present invention particularly relates to a magnesium alloy material for forming which exhibits excellent formability, a magnesium alloy formed body which is obtained by forming the magnesium alloy material for forming, and a manufacturing method of the magnesium alloy formed body.

### BACKGROUND ART

Attempts have been made to use a light-weighted magnesium alloy as a material for manufacturing members of an exterior casing of miniaturized portable electronic equipment such as mobile communication equipment or a notebook-type personal computer, a material for manufacturing members of a large-sized casing such as a traveling suitcase or a document accommodating attaché case, a material for manufacturing automobile parts such as a hood, a trunk lid, doors or fenders and the like. However, magnesium alloy exhibits poor formability and hence, it is extremely difficult to perform forming with a high degree of forming. As a method for forming such hard-to-form magnesium alloy by drawing, there have been proposed several methods including a method which heats magnesium alloy to a recrystallization temperature region at the time of forming including a method which performs drawing after heating a die, a punch, and a wrinkle pressing member of a drawing device to an approximately 150 to 400° C. (see patent document 1, for example), a magnesium-alloy-made hard-case manufacturing method which heats a die, a punch and a blank holder, and heats magnesium to a recrystallization temperature region by way of these forming tools, and forms a magnesium blank into a box shape by hot deep drawing while inducing an annealing effect in which magnesium is easily recrystallized, softened and deformed by heating (see patent document 2, for example), a method which mounts a sheet made of pure magnesium, pure aluminum, a resin or the like which is softer than a sheet made of magnesium on at least one surface of a punch and a die, and performs plastic forming (see patent document 3, for example), a method which mounts a fluororesin film on upper and lower surfaces of a heated magnesium thin plate as a heat insulating material, and performs press forming at a high temperature and the like (see patent document 4, for example). As indicated in these proposals, in performing forming such as drawing to the magnesium alloy, it is inevitable to heat the magnesium alloy to a recrystallization temperature region.

Further, there has been also proposed a method which uses a lubricant for facilitating forming. For example, there have been proposed a method which forms a super-hard thin layer made of titanium nitride or diamond-like carbon on a mold surface of a press mold by coating (see patent document 5, for example), and a method which performs forming using a plastic forming oil for magnesium alloy or aluminum alloy containing biodegradable oil and fat, a rust-proofing lubricant, an extreme-pressure additive, an organic zinc compound, and an organic molybdenum based compound (see patent document 6, for example). However, all of these methods are applicable to the cold forming and hence, in performing the forming at a forming temperature which exceeds 200° C. as in the case of the above-mentioned examples, an effective lubricating effect cannot be acquired.

As prior art literatures relevant to the present invention, the following are named.

Patent document 1: JP-A-2003-290843
Patent document 2: JP-A-2002-254115
Patent document 3: JP-A-2001-300643
Patent document 4: JP-A-06-328155
Patent document 5: JP-A-2003-154418
Patent document 6: JP-A-2003-105364

### DISCLOSURE OF THE INVENTION

### Task to be Solved by the Invention

It is an object of the present invention to provide a magnesium alloy material for forming which exhibits excellent lubricating effect within a temperature range of 350° C. or below, and can be formed into a formed body with high formability without using lubricating oil or a solid lubricant such as molybdenum disulfide, a magnesium alloy formed body which is obtained by forming the magnesium alloy material for forming by pressing, punch-stretching, drawing or the like, and a manufacturing method of the magnesium alloy formed body.

### Means for Solving the Problems

To achieve the above-mentioned object, a magnesium alloy material for forming of the present invention is formed by covering a surface of a magnesium alloy material with an organic resin which is constituted of one, two or more resins selected from a group consisting of a water-soluble urethane resin, a water-soluble polyester resin, a water-soluble acrylic resin, a water-soluble epoxy resin, and a resin produced by modification of any one of the organic resins, wherein a friction coefficient of the magnesium alloy material at a forming temperature of 350° C. or below is set to 0.2 or below (claim 1).

In the magnesium alloy material for forming (claim 1), the organic resin contains one, two or more agents selected from a group consisting of a silane coupling agent, colloidal silica, a lubricant and a metal alkoxide (claim 2).

In the magnesium alloy material for forming (claim 1 or 2), the organic resin contains a heat-resistance imparting agent (claim 3).

In the magnesium alloy material for forming (claim 3), the heat-resistance imparting agent is a siloxane compound (claim 4).

Further, the magnesium alloy formed body of the present invention is a magnesium alloy formed body which is obtained by forming the magnesium alloy material for forming (claims 1 to 4) (claim 5).

In the magnesium alloy formed body (claim 5), the magnesium alloy formed body is an automobile part (claim 6) or a container (claim 7).

In the magnesium alloy formed body (claim 7), the container is a container formed by drawing (claim 8).

In the magnesium alloy formed body (claim 7), a drawing ratio of the container formed by drawing is 4.0 or below (claim 9).

Further, the manufacturing method of a magnesium alloy formed body of the present invention includes the steps of: preparing a magnesium alloy material for forming which is formed by covering a surface of a magnesium alloy material with an organic resin which is constituted of one, two or more resins selected from a group consisting of a water-soluble urethane resin, a water-soluble polyester resin, a water-soluble acrylic resin, a water-soluble epoxy resin, and a resin produced by modification of any one of the organic resins; and forming the magnesium alloy material for forming within a temperature range of 350° C. or below (claim 10).

In the manufacturing method of a magnesium alloy formed body (claim 10), as the organic resin, an organic resin containing one, two or more agents selected from a group consisting of a silane coupling agent, colloidal silica, a lubricant and a metal alkoxide is used (claim 11).

In the manufacturing method of a magnesium alloy formed body (claim 11), as the organic resin, an organic resin further containing a heat-resistance imparting agent is used (claim 12).

In the manufacturing method of a magnesium alloy formed body (claim 12), as the heat-resistance imparting agent, a siloxane compound is used (claim 13).

### BEST MODE FOR CARRYING OUT THE INVENTION

Hereinafter, the present invention is explained in detail.

As a magnesium alloy material used in the manufacture of the magnesium alloy formed body of the present invention, it is preferable to use pure magnesium or a magnesium alloy containing 1.0 to 9.0% by weight of aluminum, 0.5 to 6.0% by weight of zinc, 0.05 to 2.0% by weight of manganese and magnesium and unavoidable impurities as a balance, and having a mean grain size of 2 to 50 μm, more preferably 2 to 10 μm (hereinafter, for the sake of brevity, both of pure magnesium and magnesium alloy being referred to as magnesium alloy). A sheet material of magnesium alloy made by extruding, cutting or hot-rolling is applicable to the following forming. In using magnesium alloy as the sheet material, a thickness of the sheet material may preferably be set to 0.05 to 3.0 mm. A magnesium alloy material for forming is produced by covering a surface of the magnesium alloy material with an organic resin.

As the organic resin which covers the surface of the magnesium alloy material by coating, it is preferable to use a water-soluble or a water-dispersing resin. That is, a water-soluble urethane resin, a water-soluble polyester resin, a water-soluble acrylic resin, and a water-soluble epoxy resin may preferably be used. A water-soluble acrylic modified polyester resin and a water-soluble phenyl silicon modified acrylic resin which are formed by modifying the above-mentioned resins may also preferably be used. These organic resins may be used in a single form or in mixture consisting of two or more kinds of resins. An addition quantity of the organic resin may preferably be set to a value which falls within a range from 20 to 85% by weight. When the addition quantity of the organic resin is less than 20% by weight, a formed organic resin film is liable to be damaged by forming and hence, the addition quantity of less than 20% by weight is not desirable. When the addition quantity of organic resin exceeds 85% by weight, although there arises no problem with respect to properties thereof, the addition quantity exceeding 85% is not economical. Further, a temperature exceeding 150° C. is often used preferably as a forming temperature of magnesium alloy material and hence, it is preferable to use an organic resin possessing the excellent heat resistance.

Although the organic resin film may be formed by applying the organic resin by coating to the above-mentioned magnesium alloy material in a single form and by drying the applied resin, to enhance the formability and the corrosion resistance, the organic resin may contain the following materials. With the addition of a silane coupling agent, the adhesiveness of the organic resin film to the magnesium alloy material, more particularly, the adhesiveness of the organic resin film to the magnesium alloy material at the time of forming can be remarkably enhanced. The silane coupling agent is classified, based on kinds of functional groups, into a vinyl-based silane coupling agent, an epoxy-based silane coupling agent, a styryl-based silane coupling agent, a methacryloxy-based silane coupling agent, an acryloxy-based silane coupling agent, an amino-based silane coupling agent, an ureide-based silane coupling agent, a chloropropyl-based silane coupling agent, a mercapto-based silane coupling agent, an isocyanate-based silane coupling agent and the like. These coupling agents can be effectively used in the manufacturing method of a magnesium alloy formed body of the present invention. This is because these silane coupling agents exhibit the excellent bonding property, that is, the excellent adhesiveness with respect to almost all resins. To be more specific, the epoxy-based silane coupling agent KBM403 exhibits excellent bonding with the urethane-based resin, the epoxy-based resin or the like, and the amino-based silane coupling agent KBM903 exhibits excellent bonding with the acrylic resin or the like and hence, these silane coupling agents exhibit excellent adhesiveness with these resins. Further, various kinds of urethane-based resins are present besides the epoxy-based silane coupling agent KBM403 and hence, the amino-based silane coupling agent KBM903 also can acquire an excellent effects. The organic resin film may preferably contain not more than 5% by weight of silane coupling agent, and may more preferably contain not more than 1% by weight of silane coupling agent. Even when an addition quantity of the silane coupling agent exceeds 5% by weight, the enhancement of adhesiveness is saturated and hence, such excessive addition of the silane coupling agent becomes economically disadvantageous.

Further, the organic resin film increases hardness by containing colloidal silica therein thus enhancing abrasion resistance and also corrosion resistance. The organic resin film may preferably contain not more than 50% by weight of colloidal silica. When an addition quantity of colloidal silica exceeds 50% by weight, the organic resin film becomes excessively hard and hence, the formability of the organic resin film is deteriorated whereby cracks are liable to easily occur in the organic resin film at the time of forming.

Further, with the addition of the lubricant in the organic resin, formability of the magnesium alloy material for forming formed by applying the organic resin film to the magnesium alloy material is enhanced. As the lubricant, a higher fatty acid such as a lauric acid, a myristic acid, a palmitic acid or a stearic acid, a calcium salt, an aluminum salt, a zinc salt, a barium salt or a magnesium salt of these higher fatty acid, ester of a higher fatty acid such as a lauric acid, a myristic acid, a palmitic acid or a stearic acid, polyolefine wax such as polyethylene wax or polypropylene wax, fluorine-based wax such as polytetrafluoroethylene, polychlorotrifluoroethylene, poly fluorine vinylidene or poly fluorine vinyl, mineral powder such as graphite, molybdenum disulfide or boron nitride can be used. The organic resin film may preferably contain not more than 20% by weight of lubricant. When an addition quantity of the lubricant exceeds 20% by weight, the adhesiveness of the organic resin film to the magnesium alloy material at the time of forming is deteriorated.

Further, with the addition of metal alkoxide in the organic resin, the heat resistance of the magnesium alloy material for forming formed by applying the organic resin film to the magnesium alloy material can be enhanced. As metal alkoxide, alkoxide of boron, aluminum, titanium, vanadium, manganese, iron, cobalt, copper, yttrium, zirconium, niobium, lantern, cerium, tantalum or tungsten can be named. Among these metal alkoxides, titanium-based alkoxide can preferably be used. The organic resin film may preferably contain not more than 10% by weight of metal alkoxide therein. When an addition quantity of metal alkoxide exceeds 10% by weight, formability of the magnesium alloy material for forming formed by applying the organic resin film to the magnesium alloy material is lowered. Although the organic resin film may contain one kind of agent selected from the above-mentioned group consisting of silane coupling agent, the colloidal silica, the lubricant and the metal alkoxide in a single form, the organic resin film may contain two or more kinds of these materials.

By applying the organic resin acquired by the above-mentioned manner to the surface of the magnesium alloy material and by drying the organic resin, the organic resin film is formed. A thickness of the organic resin film may preferably be 0.1 to 50 μm, and more preferably be 1 to 10 μm with respect to the thickness after drying. Although the magnesium alloy material for forming is acquired in this manner, a friction coefficient of a surface of the magnesium alloy material for forming at a forming temperature may preferably be set to 0.2 or below. The friction coefficient at a forming temperature is a value of a friction coefficient at a temperature at which the magnesium alloy material for forming is formed and is measured using a contact-type friction coefficient measuring device made by SHINTO Scientific Co., ltd. (HEIDON) (Dynamic Strain Amplifier 3K-34D, Peeling/Slipping/Scratching TESTER HEIDON-14).

The magnesium alloy material for forming obtained by the above-mentioned steps exhibits the friction coefficient at a forming temperature of 0.2 or below and hence, the magnesium alloy material for forming exhibits excellent formability. Accordingly, the magnesium alloy material for forming can be preferably formed without using lubricating oil or a solid lubricant such as molybdenum disulfide which have been usually used in applications such as drawing, forging, rolling and press forging. Further, the magnesium alloy material for forming can be also preferably formed using the lubricating oil or the solid lubricant such as molybdenum disulfide which have been usually used in combination with the organic resin film and hence, the magnesium alloy material for forming can be continuously formed in conventional manufacturing steps which include an oil coating step by using the conventional manufacturing method of magnesium alloy material which requires coating of lubricating oil and the manufacturing method of the present invention which requires no oil coating in combination. Further, by drawing the magnesium alloy material for forming by heating the magnesium alloy material for forming within a temperature range not more than 350° C., more preferably within a hot forming temperature range from 200 to 350° C., the formability is further enhanced compared to the forming performed within a temperature range of less than 200° C. and hence, the magnesium alloy material for forming can be formed at high formability. However, when the forming is performed within the temperature range exceeding 200° C., the organic resin film is discolored by decomposion, or cracks occur in the organic resin film thus deteriorating appearance and, at the same time, making the enhancement of formability difficult. Accordingly, in addition to the enhancement of heat resistance using the organic resin alone, by allowing the organic resin film to further contain a heat resistance imparting agent, it is possible to perform forming of the magnesium alloy material for forming in a stable manner without discoloring the organic resin film or generating cracks in the organic resin film within a hot forming temperature range of high temperature from 200 to 350° C. whereby the formability can be also enhanced. As a result, in the forming of the magnesium alloy material for forming, the forming temperature which enables the acquisition of formability equal to the formability obtained by the conventionally exercised forming which uses the lubricating oil can be further lowered within the temperature range of not more than 350° C. and hence, it is possible to acquire an advantageous effect that the excessive heat treatment becomes unnecessary. It is needless to say that coating of the lubricating oil at the time of forming becomes unnecessary.

As the heat-resistance imparting agent, a heat-resistant resin such as polyimide or siloxane compound may preferably be used. As a siloxane compound, a polymer or a monomer of organosiloxane such as dimethylsiloxane, diethyl siloxane, methylethyl siloxane, diphenyl siloxane, methylphenyl siloxane, or polymer or monomer of organosiloxane molecules which contains at least one substituent group or two or more substituent groups consisting of one kind, two or more kinds of polyalkylene oxide group, hydroxyl group, amide group, carboxyl group, sulfone group and amino group may preferably be used. The organic resin film may preferably contain 5 to 80% by weight of heat-resistance imparting agents, and more preferably 10 to 60% by weight of heat-resistance imparting agent. By adding the heat-resistance imparting agent to the organic resin film in this manner, it is possible to perform forming with high formability by heating the magnesium alloy sheet for forming up to the hot forming temperature range from 200 to 350° C. Here, although the organic resin may contain the heat-resistance imparting agent in a single form, the organic resin may contain the heat-resistance imparting agent in combination with one kind or two kinds or more of the above-mentioned silane coupling agent, the colloidal silica and the lubricant.

With respect to the magnesium alloy formed body which is obtained in this manner, coating may be applied to the organic resin film when necessary. Alternatively, the magnesium alloy formed body may be manufactured by forming a coated material which is produced by preliminarily applying coating on an organic resin film of the above-mentioned magnesium alloy material for forming. It is needless to say that the magnesium alloy material for forming can be used in a state where the magnesium alloy material is covered with only the organic resin film in a single form. Further, after forming magnesium alloy formed body using the magnesium alloy material for forming, the organic resin film may be dissolved and removed using an alkaline solution, or the organic resin film may be removed by a shot blast method which blows abrasive particles on a surface of the organic resin film and, thereafter, a surface treatment such as a known anodizing treatment or plating may be applied to the magnesium alloy formed body, or coating may be further applied to the magnesium alloy formed body to which the surface treatment is applied.

### Embodiment

Hereinafter, the present invention is explained in detail in conjunction with embodiments.

### (Preparation of Magnesium Alloy Material for Forming)

As the magnesium alloy material for forming, magnesium alloy material for formings for testing which are given sample numbers 1 to 13 are prepared in the following manner. That is, to both surfaces of a magnesium alloy sheet containing following alloy contents and having a sheet thickness of 0.4 mm, a resin solution shown in Table 1 or a resin solution which is prepared by adding a silane coupling agent, colloidal silica, a lubricant, a metal alkoxide or a heat resistance-imparting agent shown in Table 1 to the resin shown in Table 1 is applied using a bar coater and is dried such that respective additives exhibit contents shown in Table 1 in a post-drying state and a thickness of the resin film after drying assumes a value shown in Table 1.

### <Alloy Contents>

Al: 3.1% by weight, Zn: 1.1% by weight, Mn: 0.31% by weight, balance: Mg and unavoidable impurity elements

### <Average Grain Size>

8 μm

TABLE 1

| | | | | | | | | | | heat | | |
|---|---|---|---|---|---|---|---|---|---|---|---|---|
| | water-soluble | | | | | | | | | resistance- | | |
| | resin | | silane coupling | | colloidal | | | metal | | imparting | | |
| | | content | agent | | silica | lubricant | | alkoxide | | agent | | film |
| sample | | (weight | | content | content | | content | | content | | content | thickness |
| number | kind | %) | kind | (weight %) | (weight %) | kind | (weight %) | kind | (weight %) | kind | (weight %) | (μm) |
| 1 | URE | 80.0 | — | — | 10 | PTFE | 10 | — | — | — | — | 43 |
| 2 | URE | 59.5 | KMB903 | 0.5 | 35 | PTFE | 5 | — | — | — | — | 2 |
| 3 | URE | 40.0 | KMB903 | 1.0 | 50 | — | — | — | — | DMSX | 9 | 6 |
| 4 | AC-PES | 34.5 | KMB403 | 0.5 | 15 | PTFE | 15 | — | — | DMSX | 35 | 8 |
| 5 | PES | 68.0 | KMB903 | 2.0 | 15 | PTFE | 15 | — | — | — | — | 3 |
| 6 | PES | 80.5 | KMB403 | 4.5 | — | PTFE | 15 | — | — | — | — | 6 |
| 7 | ACR | 61.0 | KMB903 | 1.0 | 15 | PTFE | 20 | TIET | 3.0 | — | — | 0.4 |
| 8 | ACR | 34.5 | KMB903 | 0.5 | 25 | — | — | — | — | MPSX | 40 | 5 |
| 9 | ACR | 47.0 | — | — | 48 | — | — | — | — | MPSX | 5 | 10 |
| 10 | EF-ACR | 64.5 | KMB403 | 0.5 | 20 | PTFE | 10 | TIET | 5.0 | — | — | 1.5 |
| 11 | EPO | 21.0 | KMB403 | 1.0 | — | — | — | — | — | DMSX | 78 | 35 |
| 12 | EPO | 40.0 | — | — | 25 | PTFE | 10 | — | — | DMSX | 25 | 5 |
| 13 | URE + | 80.0 | — | — | 5 | PTFE | 5 | — | — | MPSX | 10 | 5 |
| | EPO | | | | | | | | | | | |
| 14 | — | — | — | — | — | — | — | — | — | — | — | — |
| 15 | — | — | — | — | — | — | — | — | — | — | — | F resin |
| | | | | | | | | | | | | 50 μm |

Note)
URE: urethane,
PES: polyester,
ACR: acryclic,
EPO: epoxy,
AC-PES: acryl-modified epoxy,
EF-ACR: phenyl silicon modified acrylic,
KMB903: amino-based silane coupling agent made by Shin-Etsu chemical Co., Ltd.,
KMB403: epoxy-based silane coupling agent made by Shin-Etsu Chemical Co., Ltd.,
TIET: titanium ethoxide,
PTFE: polytetrafluoroethylene,
DMSX: dimethylsiloxane,
MPSX: methylphenylsiloxane,
F resin: applying fluororesin film having a thickness of 50 μm to upper and lower surfaces of magnesium alloy sheet at the time of drawing

### (Preparation of Magnesium Alloy Formed Body)

The magnesium alloy sheets for forming for testing which are obtained by the above-mentioned manner and are given sample numbers 1 to 13 are formed into a container by drawing under following conditions. With respect to the forming temperatures, a dice and a blank holder have the same temperature and only the temperature of a punch is set to a room temperature. Limiting drawing ratios of the formed bodies at the time of drawing are obtained and formability of these formed bodies is evaluated. Further, a friction coefficient at a forming temperature is measured using a friction coefficient measuring device made by SHINTO Scientific Co., ltd. (HEIDON) to which a holder heater is attached. In measuring the friction coefficient, the magnesium alloy material for forming fixed to the holder is heated at a forming temperature and, thereafter, the friction coefficient is measured under conditions where a stainless steel ball having a diameter of 10 mm attached to the device is used as a contact ball, a measuring weight is set to 200 g, and a measuring time is set to 1.6 mm/sec.

### <Radius of Curvature R of Punch Shoulder>

5 mm

### <Punch Temperature>

### 25° C.

### <Dice Temperature>

### 150° C., 200° C., 250° C., 300° C., 350° C.

### <Blank Holder Temperature>

### 150° C., 200° C., 250° C., 300° C., 350° C.

### <Drawing Speed>

1 mm/sec

### <Lubricating Oil and Lubricant>

Neither Lubricating oil nor lubricant is used at the time of forming the magnesium alloy material of the present invention.

As comparison examples, magnesium alloy formed bodies are prepared in the following manner. That is, the magnesium alloy formed body having a sample number 14 is prepared as the comparison example by applying commercially available lubricating oil G3080 (made by NIHON KOHSAKUYU CO., LTD.) to both surfaces of the above-mentioned magnesium alloy material, and the magnesium alloy formed body having a sample number 15 is prepared as the comparison example by mounting a fluororesin film having a thickness of 50 μm on both surfaces of the magnesium alloy material. Then, drawing is applied to these comparison examples having the sample numbers 14, 15 under the substantially same conditions thus preparing the magnesium alloy formed bodies for comparison. Here, with respect to the magnesium alloy material having the sample number 14 on which a fluororesin film is not mounted, formability when a forming temperature is low is extremely deteriorated thus making drawing of the magnesium alloy difficult. Accordingly, drawing is performed only when a dice temperature and a blank holder temperature are 200° C. or above. Further, with respect to the magnesium alloy material having the sample number 15 which mounts a fluororesin film thereon, when a dice temperature and a blank holder temperature are 350° C., the fluororesin film is heavily damaged thus making drawing of the magnesium alloy material difficult. Accordingly, drawing is applied to the magnesium alloy material only when the dice temperature and the blank holder temperature fall within a range from 150° C. to 300° C.

### (Evaluation of Appearance of Organic Resin Film)

Appearances of organic resin films formed on surfaces of the magnesium alloy formed bodies (containers formed by drawing) after forming are observed with naked eyes and are evaluated based on the following criteria.

Excellent: Neither discoloring nor damages of the film are recognized.
Good: Although slight discoloring of film is recognized, damages of the film which cause a serious problem in practical use are not recognized.
Fair: Although discoloring and damages of film are recognized, the magnesium alloy material can be formed into a shape of the formed body (container formed by drawing), and can be directly used as an interior member. Further, by applying a simple treatment removing abrasion or the like to the film, aesthetic appearance can be obtained and hence, the magnesium alloy formed body can be sufficiently used as an exterior member.
Bad: Heavy damages on the film are recognized and, at the same time, abrasions which cause a serious problem in practical use are formed on the surface of the formed body (container formed by drawing).

Results of these evaluations are shown in Tables 2 to 4.

TABLE 2

| | | | | sample | | | | | |
|---|---|---|---|---|---|---|---|---|---|
| | | | | temperature | | | | | |
| | | | | at the time | | | | | |
| | | | | of | | | | | |
| | | | | measuring | | use of | | | |
| | tool | | | friction | | lubricating | limiting | appearance | |
| sample | temperature (° C.) | | | coefficient | friction | oil or | drawing | of organic | |
| number | punch | dice | blank holder | (° C.) | coefficient | lubricant | ratio | resin film | distinction |
| 1-1 | 25 | 150 | 150 | 150 | 0.19 | not used | 1.9 | excellent | present invention |
| 1-2 | 25 | 200 | 200 | 200 | 0.16 | not used | 2.6 | good | present invention |
| 1-3 | 25 | 250 | 250 | 250 | 0.12 | not used | 3.2 | good | present invention |
| 1-4 | 25 | 300 | 300 | 300 | 0.09 | not used | 2.8 | fair | present invention |
| 2-1 | 25 | 150 | 150 | 150 | 0.20 | not used | 1.8 | excellent | present invention |
| 2-2 | 25 | 200 | 200 | 200 | 0.17 | not used | 2.4 | good | present invention |
| 2-3 | 25 | 250 | 250 | 250 | 0.14 | not used | 2.9 | good | present invention |
| 2-4 | 25 | 300 | 300 | 300 | 0.11 | not used | 2.6 | fair | present invention |
| 3-1 | 25 | 150 | 150 | 150 | 0.18 | not used | 2.0 | excellent | present invention |
| 3-2 | 25 | 200 | 200 | 200 | 0.16 | not used | 3.0 | excellent | present invention |
| 3-3 | 25 | 250 | 250 | 250 | 0.13 | not used | 3.8 | excellent | present invention |
| 3-4 | 25 | 300 | 300 | 300 | 0.10 | not used | 3.8 | excellent | present invention |
| 3-5 | 25 | 350 | 350 | 350 | 0.09 | not used | 3.6 | good | present invention |
| 4-1 | 25 | 150 | 150 | 150 | 0.17 | not used | 2.2 | excellent | present invention |
| 4-2 | 25 | 200 | 200 | 200 | 0.15 | not used | 3.2 | excellent | present invention |
| 4-3 | 25 | 250 | 250 | 250 | 0.13 | not used | 4.0 | excellent | present invention |
| 4-4 | 25 | 300 | 300 | 300 | 0.11 | not used | 4.0 | excellent | present invention |
| 4-5 | 25 | 350 | 350 | 350 | 0.09 | not used | 3.8 | good | present invention |

TABLE 3

| | | | | sample | | | | | |
|---|---|---|---|---|---|---|---|---|---|
| | | | | temperature | | | | | |
| | | | | at the time | | | | | |
| | tool | | | of | | | | | |
| | temperature | | | measuring | | use of | | | |
| | (° C.) | | | friction | | lubricating | limiting | appearance | |
| sample | | | blank | coefficient | friction | oil or | drawing | of organic | |
| number | punch | dice | holder | (° C.) | coefficient | lubricant | ratio | resin film | distinction |
| 5-1 | 25 | 200 | 200 | 200 | 0.15 | not used | 3.3 | excellent | present invention |
| 5-2 | 25 | 250 | 250 | 250 | 0.14 | not used | 3.5 | good | present invention |
| 5-3 | 25 | 300 | 300 | 300 | 0.11 | not used | 3.3 | fair | present invention |
| 6-1 | 25 | 150 | 150 | 150 | 0.19 | not used | 2.4 | excellent | present invention |
| 6-2 | 25 | 200 | 200 | 200 | 0.17 | not used | 3.2 | good | present invention |
| 6-3 | 25 | 300 | 300 | 300 | 0.11 | not used | 3.0 | fair | present invention |
| 7-1 | 25 | 150 | 150 | 150 | 0.17 | not used | 2.2 | excellent | present invention |
| 7-2 | 25 | 200 | 200 | 200 | 0.14 | not used | 2.6 | good | present invention |
| 7-3 | 25 | 300 | 300 | 300 | 0.10 | not used | 2.3 | fair | present invention |
| 8-1 | 25 | 200 | 200 | 200 | 0.17 | not used | 2.8 | excellent | present invention |
| 8-2 | 25 | 250 | 250 | 250 | 0.15 | not used | 3.5 | excellent | present invention |
| 8-3 | 25 | 350 | 350 | 350 | 0.11 | not used | 3.2 | good | present invention |
| 9-1 | 25 | 200 | 200 | 200 | 0.13 | not used | 2.8 | excellent | present invention |
| 9-2 | 25 | 250 | 250 | 250 | 0.12 | not used | 3.5 | excellent | present invention |
| 9-3 | 25 | 300 | 300 | 300 | 0.11 | not used | 3.5 | excellent | present invention |
| 10-1 | 25 | 150 | 150 | 150 | 0.16 | not used | 2.0 | excellent | present invention |
| 10-2 | 25 | 200 | 200 | 200 | 0.15 | not used | 2.8 | good | present invention |
| 10-3 | 25 | 300 | 300 | 300 | 0.11 | not used | 2.3 | fair | present invention |
| 11-1 | 25 | 200 | 200 | 200 | 0.15 | not used | 2.6 | excellent | present invention |
| 11-2 | 25 | 250 | 250 | 250 | 0.14 | not used | 3.1 | excellent | present invention |
| 11-3 | 25 | 300 | 300 | 300 | 0.13 | not used | 3.1 | excellent | present invention |
| 12-1 | 25 | 200 | 200 | 200 | 0.14 | not used | 2.5 | excellent | present invention |
| 12-2 | 25 | 250 | 250 | 250 | 0.12 | not used | 3.0 | excellent | present invention |
| 12-3 | 25 | 300 | 300 | 300 | 0.10 | not used | 3.0 | excellent | present invention |

TABLE 4

| | | | | sample | | | | | |
|---|---|---|---|---|---|---|---|---|---|
| | | | | temperature | | | | | |
| | tool | | | at the time | | | | | |
| | temperature | | | of measuring | | use of | | | |
| | (° C.) | | | friction | | lubricating oil | limiting | appearance | |
| sample | | | blank | coefficient | friction | or | drawing | of organic | |
| number | punch | dice | holder | (° C.) | coefficient | lubricant | ratio | resin film | distinction |
| 13-1 | 25 | 200 | 200 | 200 | 0.14 | not used | 2.4 | excellent | present invention |
| 13-2 | 25 | 250 | 250 | 250 | 0.12 | not used | 3.0 | excellent | present invention |
| 13-3 | 25 | 300 | 300 | 300 | 0.10 | not used | 2.9 | good | present invention |
| 14-1 | 25 | 200 | 200 | 200 | 0.28 | lubricating oil | 1.5 | — | comparison example |
| 14-2 | 25 | 250 | 250 | 250 | 0.28 | lubricating oil | 1.8 | — | comparison example |
| 14-3 | 25 | 300 | 300 | 300 | 0.30 | lubricating oil | 1.8 | — | comparison example |
| 15-1 | 25 | 150 | 150 | 150 | 0.20 | F resin 50 μm | 1.4 | — | comparison example |
| 15-2 | 25 | 200 | 200 | 200 | 0.20 | F resin 50 μm | 2.7 | — | comparison example |
| 15-3 | 25 | 250 | 250 | 250 | 0.20 | F resin 50 μm | 3.4 | — | comparison example |
| 15-4 | 25 | 300 | 300 | 300 | 0.18 | F resin 50 μm | 3.0 | — | comparison example |

Note)
—: not evaluated
F resin: fluororesin film having film thickness of 50 μm being mounted on upper and lower surfaces of magnesium alloy sheet at the time of drawing

As shown in Tables 2 to 4, the magnesium alloy material for forming of the present invention which is formed by covering the magnesium alloy sheet with the organic resin exhibits excellent formability. That is, compared to the comparison example (sample number 14) which is formed by a conventional method in which lubricating oil is applied to the magnesium alloy sheet and drawing is applied to the magnesium alloy sheet thereafter, the magnesium alloy material for forming of the present invention exhibits extremely excellent formability. Further, compared to the comparison example (sample number 15) which uses an expensive fluororesin film as a lubricant and has been mainly used in research and development because of the most excellent formability in the past, the magnesium alloy material for forming according to the present invention exhibits the equivalent or more formability. Accordingly, as a method which replaces a method using a fluororesin film which has a drawback in cost and productivity in mass production, the superiority of the magnesium alloy material for forming according to the present invention is apparent. Further, when the organic resin contains the heat-resistance imparting agent, drawing can be applied to the magnesium alloy material for forming at a high temperature up to 350° C. When drawing is applied to the magnesium alloy material for forming at such a high temperature, the magnesium alloy material for forming can be formed into the magnesium alloy formed body (container formed by drawing) by drawing with high degree of formability, wherein a limiting drawing ratio may take 4.0 as a maximum value.

### INDUSTRIAL APPLICABILITY

The magnesium alloy sheet for forming of the present invention which is formed by covering the surface of the magnesium alloy material with the organic resin which possesses lubricating property can be formed into the magnesium alloy formed body with high formability. Particularly, when the organic resin contains the heat-resistance imparting agent such as a siloxane compound, the magnesium alloy sheet of the present invention exhibits the excellent lubricating effect within a hot forming temperature range from 200 to 350° C. Accordingly, the magnesium alloy sheet for forming of the present invention can be used as a material for manufacturing the magnesium alloy formed bodies which include automobile parts such as a hood, a trunk lid, doors or fenders, a miniaturized exterior casing of portable electronic equipment such as a mobile communication equipment or a notebook-type personal computer, and a large-sized casing such as a traveling suitcase or a document accommodating attach case. The magnesium alloy sheet for forming of the present invention can be particularly used for manufacturing a container formed by drawing with high formability in which a drawing ratio is 4.0 or below.

1. A magnesium alloy material for forming, the magnesium alloy material being formed by covering a surface of a magnesium alloy material with an organic resin which is constituted of one, two or more resins selected from a group consisting of a water-soluble urethane resin, a water-soluble polyester resin, a water-soluble acrylic resin, a water-soluble epoxy resin, and a resin produced by modification of any one of the organic resins, wherein a friction coefficient of the magnesium alloy material at a forming temperature of 350° C. or below is set to 0.2 or below.

2. A magnesium alloy material for forming according to claim 1, wherein the organic resin contains one, two or more agents selected from a group consisting of a silane coupling agent, colloidal silica, a lubricant and a metal alkoxide.

3. A magnesium alloy material for forming according to claim 1, wherein the organic resin contains a heat-resistance imparting agent.

4. A magnesium alloy material for forming according to claim 3, wherein the heat-resistance imparting agent is a siloxane compound.

5. A magnesium alloy formed body which is obtained by forming the magnesium alloy material for forming according to claim 1.

6. A magnesium alloy formed body according to claim 5, wherein the magnesium alloy formed body is an automobile part.

7. A magnesium alloy formed body according to claim 5, wherein the magnesium alloy formed body is a container.

8. A magnesium alloy formed body according to claim 7, wherein the container is a container formed by drawing.

9. A magnesium alloy formed body according to claim 8, wherein a drawing ratio of the container formed by drawing is 4.0 or below.

10. A manufacturing method of a magnesium alloy formed body comprising the steps of:
preparing a magnesium alloy material for forming which is formed by covering a surface of a magnesium alloy material with an organic resin which is constituted of one, two or more resins selected from a group consisting of a water-soluble urethane resin, a water-soluble polyester resin, a water-soluble acrylic resin, a water-soluble epoxy resin, and a resin produced by modification of any one of the organic resins; and
forming the magnesium alloy material for forming within a temperature range of 350° C. or below.

11. A manufacturing method of a magnesium alloy formed body according to claim 10, wherein as the organic resin, an organic resin containing one, two or more agents selected from a group consisting of a silane coupling agent, colloidal silica, a lubricant and a metal alkoxide is used.

12. A manufacturing method of a magnesium alloy formed body according to claim 11, wherein as the organic resin, an organic resin further containing a heat-resistance imparting agent is used.

13. A manufacturing method of a magnesium alloy formed body according to claim 12, wherein as the heat-resistance imparting agent, a siloxane compound is used.
